(19) United States
(12) Patent Application Publication
(10) Pub. No.: US 2015/0151393 A1
(43) Pub. Date: Jun. 4, 2015

(54) MACHINING MECHANISM AND MACHINE TOOL AND METHOD FOR MACHINING USING THE MACHINE TOOL

(71) Applicants: Fu Tai Hua Industry (Shenzhen) Co., Ltd., Shenzhen (CN); HON HAI PRECISION INDUSTRY CO., LTD., New Taipei (TW)

(72) Inventors: XUE-SONG WANG, Shenzhen (CN); DE-JI ZHUANG, Shenzhen (CN)

(73) Assignees: HON HAI PRECISION INDUSTRY CO., LTD., New Taipei (TW); FU TAI HUA INDUSTRY (SHENZHEN) CO., LTD., Shenzhen (CN)

(21) Appl. No.: 14/526,780

(22) Filed: Oct. 29, 2014

(30) Foreign Application Priority Data
Nov. 30, 2013 (CN) 201310622197.8

(51) Int. Cl. B23Q 1/25; B23C 1/12

(52) U.S. Cl. CPC B23Q 1/25; B23C 1/12

(57) ABSTRACT

A machining mechanism includes a connecting base, a main shaft, a milling cutting tool, and a plane assembly. The main shaft includes a fixing portion and a rotation housing portion coupled to the fixing portion. The fixing portion is fixedly coupled to the connecting base. The milling cutting tool is hold by the rotation housing portion. The plane assembly is fixed to the fixing portion and includes a tool bracket and a plane hold by the tool bracket. The tool bracket includes a locating portion and a mounting portion coupled to the locating portion. The locating portion is fixed to the fixing portion. The locating portion and the mounting portion cooperative form a V-shaped structure. The planting tool inclinably extends from the mounting portion and derivates from the locating portion. The disclosure also supplies a machine tool using the machining mechanism and a method for machining using the machine tool.

### FIELD

The subject matter herein generally relates to a machining mechanism with a milling cuter and a plane, a machine tool using the machining mechanism, and a method for machining a workpiece using the machine tool.

### BACKGROUND

Machine tool is used for machining workpieces. Some workpieces need to be machined with different treatments, such as milling, and lathing.

### BRIEF DESCRIPTION OF THE DRAWINGS

Implementations of the present technology will now be described, by way of example only, with reference to the attached figures.

FIG. 1 is an assembled, isometric view of a first embodiment of a machine tool including a machining mechanism and a worktable.

FIG. 2 is an assembled, isometric view of the machining mechanism having a plane and the worktable of FIG. 1.

FIG. 3 is an exploded view of the machining mechanism and the worktable.

FIG. 4 is a diagrammatic view of a plane of a machining mechanism of a second embodiment.

FIG. 5 is a diagrammatic view of a plane of a machining mechanism of a third embodiment.

FIG. 6 is a flowchart of a process for machining using the machine tool of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “substantially” is defined to be essentially conforming to the particular dimension, shape or other word that substantially modifies, such that the component need not be exact. For example, substantially cylindrical means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

The present disclosure is described in relation to a machining mechanism, a machine tool using the machining mechanism, and a method for machining using the machine tool. A machining mechanism can include a connecting base, a main shaft housing, a rotatable milling cutting tool, and a plane assembly. The connecting base can be connectable to a machine tool. The main shaft housing can be coupled to a surface of the connecting base. The main shaft housing can include a fixing portion coupled to the connecting base and a rotation housing portion extending from a surface of the fixing portion opposite to and substantially parallel to the surface of the fixing portion coupled to the connecting base. The rotatable milling cutting tool can extend out from the rotation housing portion opposite the fixing portion. The plane assembly can be attached to the fixing portion. The plane assembly can include a tool bracket and a plane. The tool bracket can have locating portion and a mounting portion. The mounting portion can be substantially parallel to the main shaft, and spaced apart from the milling cutting tool. The locating portion with the mounting portion can extend at an angle from the locating portion. The locating portion of the tool bracket is attached to the fixing portion and the plane extends at an angle from the mounting portion away from the locating portion.

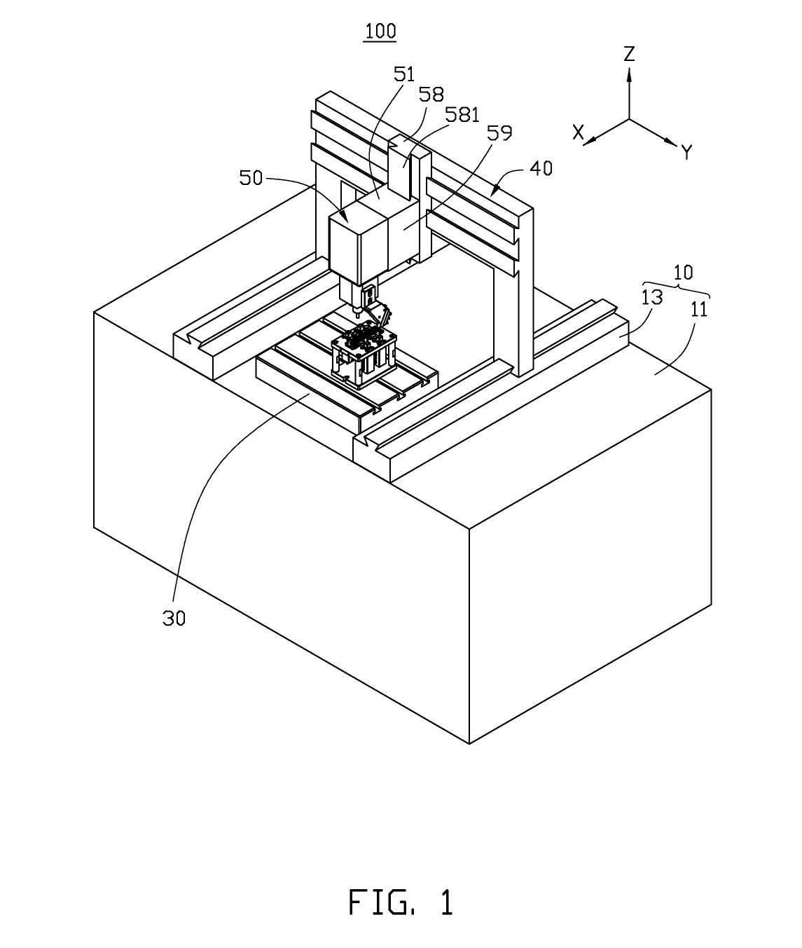

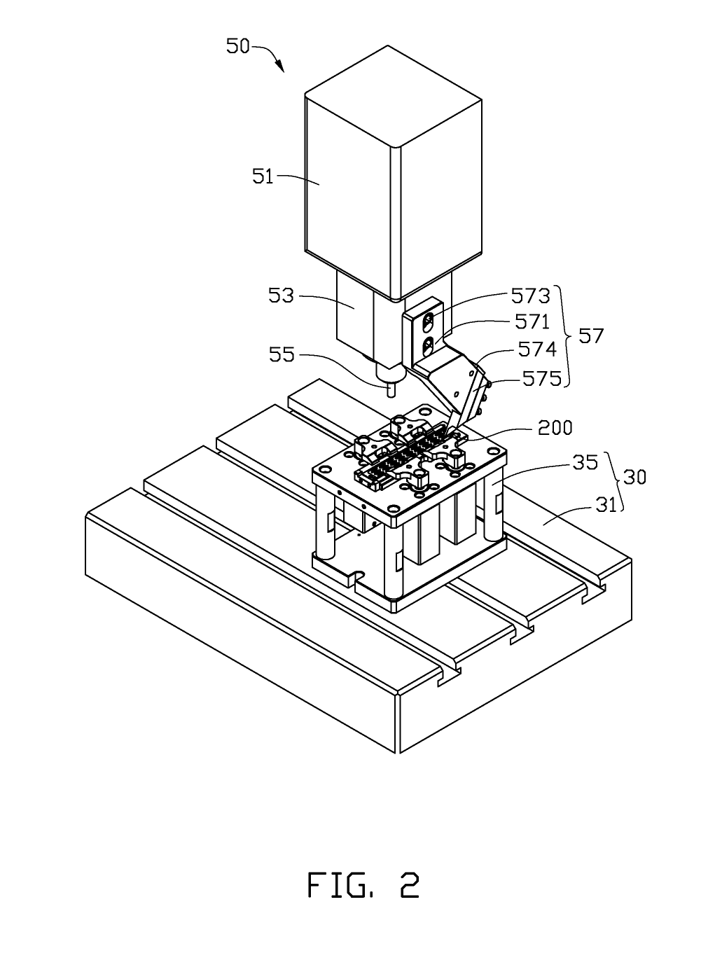

FIG. 1 illustrates a machine tool 100 of a first embodiment for milling and planing a workpiece 200 (as shown in FIG. 2). The machine tool 100 can include a support 10, a worktable 30, a moving assembly 40, and a machining mechanism 50. The worktable 30 can be positioned on the support 10. The moving assembly 40 can be movably positioned on the support 10 along a first direction X. The machining mechanism 50 can be slidably positioned on the moving assembly 40 along a second direction Y, which is substantially perpendicularly to the first direction X. The machining mechanism 50 can also move along a third direction Z substantially perpendicularly to the first direction X and the second direction Y relative to the moving assembly 40. In the illustrated embodiment, other configurations of the machine tool 100, such as a controller, are not described here for simplicity.

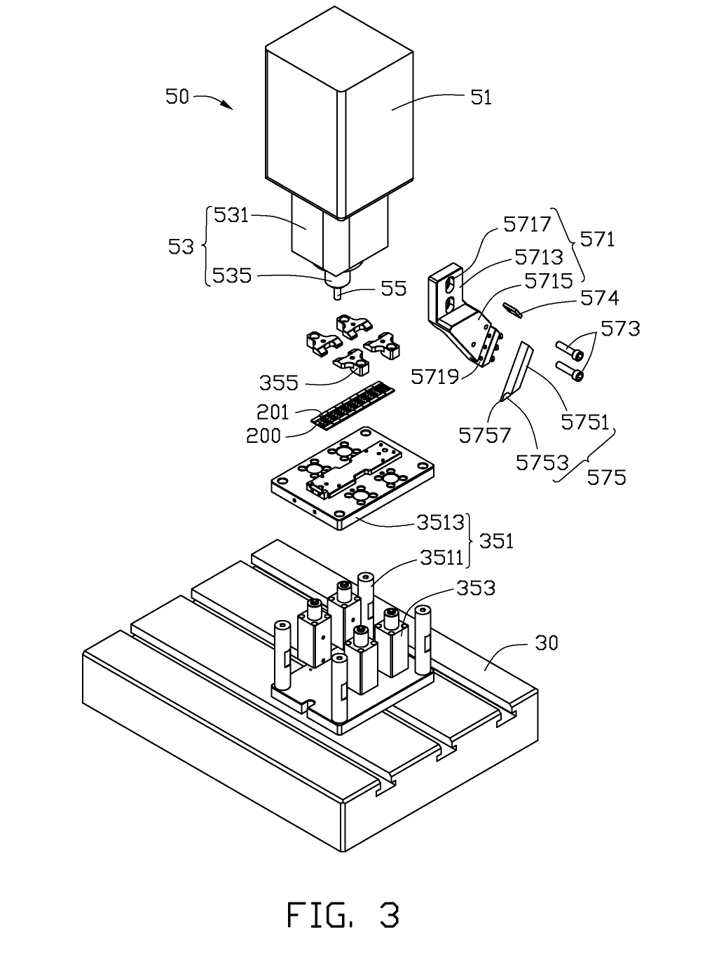

The support 10 can include a base 11 and a pair of guiding rails 13 protruding from the base 11 in parallel. The pair of guiding rails 13 can extend along the first direction X. The worktable 30 can be positioned on the base 11 and located between the pair of guiding rails 13 for supporting workpieces 200. FIG. 2 illustrates the worktable 30 can include a base body 31 and a clamping device 35 positioned on the base body 31. The base body 31 can be positioned on the base 11. FIG. 3 illustrates the clamping device 35 can include a frame 351, four driving members 353, and four resisting members 355. The frame 351 can include a bottom seat 3511 and a top board 3513 fixed on the bottom base 3511. The four driving members 353 can be divided into two groups each including two driving members 353. The driving members 353 can be mounted on the top board 3513 and received in the frame 351. A part of each driving member 353 can protrude out from the top board 3513 of the frame 351. In the illustrated embodiments, the four driving members 353 are rotary cylinders. The resisting members 353 can be located outside of the frame 351 and above the top board 3513. Each resisting member 355 can fixedly coupled to one driving member 353 protruding from the frame 351. The resisting members 355 can be configured to be rotated by the driving members 353 to position the workpiece 200 on the top board 3513 or release the workpiece 200. The moving assembly 40 can be slidably positioned on the pair of guiding rails 13.

FIG. 3 illustrates the machining mechanism 50 can include a connecting base 51, a main shaft 53, a rotatable milling cutting tool 55, and a plane assembly 57. The connecting base 51 can be positioned on the moving assembly 40. The main shaft 53 can include a fixing portion 531 and a rotation housing portion 535 rotatably coupled to the fixing portion 531. The fixing portion 531 can pass through the connecting base 51 and fixedly coupled to the connecting base 51. The fixing portion 531 can protrude from the connecting base 51 and extend toward the support 10. The rotation housing portion 535 can be located above the worktable 30. The milling cutting tool 55 can be stably held by the rotation housing portion 535. The rotation housing portion 535 can be configured to rotate the milling cutting tool 55 at high speed for milling the workpiece 200.

The plane assembly 57 can be fixed on a sidewall of the fixing portion 531 and spaced from the milling cutting tool 55. The plane assembly 57 can include a tool bracket 571, a pair of locking members 573, a positioning block 574, and a plane 575. The tool bracket 571 can include a locating portion 5713 and a mounting portion 5715. The locating portion 5713 can be fixed on the fixing portion 531. The locating portion 5713 is substantially parallel to a vertical axis of the main shaft 53. Two locking holes 5717 can be separately defined in the locating portion 5713. The mounting portion 5715 can extend from one end of the locating portion 5713 away from the fixing portion 531 at an angle and extend toward the support 10, such that the mounting portion 5715 and the locating portion 5713 can cooperatively form a V-shaped structure.

The angle formed between the locating portion 5713 and the mounting portion 5715 can be greater than 90 degrees and less than 180 degrees. An angle formed between the locating portion 5713 and a direction parallel to the first direction X is less than 90 degrees. A strip-shaped and inclined receiving groove 5719 can be defined in the mounting portion 5715 away from the locating portion 5713 for holding the plane 575. The receiving groove 5719 can extend through two opposite sidewalls of the mounting portion 5715. The positioning block 574 can be located on the mounting portion 5715 and close one end of the receiving groove 5179 away from the support 10. Each locking member 573 can pass through one locking hole 5717 and fixed with the fixing portion 531 for fixing the tool bracket 571 on the main shaft 53. The plane 575 can be mounted in and received in the receiving groove 5719. One end portion of the plane 575, which has a cutting edge 5757, can protrude from the receiving groove 5719 and extend toward the support 10, such that the plane 575 and the mounting portion 5715 can cooperative form a V-shaped structure. An angle formed between the mounting portion 5715 and the plane 575 can be greater than 90 degrees and less than 180 degrees. The mounting portion 5175 can extend from the locating portion 5713 at one obtuse angle, and the plane 575 can coupled with the mounting portion 5175 at an obtuse angle and the plane 575 can extend toward the support 10. Thus, the plane 575 can be protected from impact in machining. An obtuse angle is greater than 90 degrees and less than 180 degrees.

In the illustrated embodiment, an extension direction of the locating portion 5713 can be parallel to the main shaft 53, and the plane 575 can extend from a second end of the mounting portion 5715 toward the support 10. Extension direction of the locating portion 5713 and the plane 575 can form a certain angle, not be arranged in line. The plane 575 can include a positioning portion 5751 and a cutting portion 5753 extending from the positioning portion 5751. The positioning portion 5751 can be fixed in the receiving groove 5719. An end surface of the positioning portion 5751 away from the cutting portion 5753 can resist against the positioning block 574. The cutting edge 5757 can be formed in an end edge of the cutting portion 5753 away from the positioning portion 5751. The cutting edge 5757 can be a profile cutting edge. In the illustrated embodiment, a profile of the cutting edge 5757 of the plane 575 is in an actuate shape. In other embodiments, the cutter edge 5757 can be in other shapes for planing out other surfaces. A gap between the cutting edge 5757 of the scarping cutter 575 and the milling cutting tool 55 is large enough for independent machining.

Referring to FIG. 1 again, the machining mechanism 50 can further include a saddle 58 and a sliding member 59. The saddle 58 can be slidably engaged with the moving assembly 40 for moving the machining mechanism 50 along the second direction Y. A sliding rail 581 can be positioned on a side surface of the saddle 58 facing towards the sliding member 59 along the third direction Z. The sliding member 59 can be slidably engaged with the sliding rail 581.

In assembly, the worktable 30 can be fixed on the support 10. The moving assembly 40 can be slidably positioned on the pair of guiding rails 13. The machining mechanism 50 can be slidably positioned on the moving assembly 40. In details, the connecting base 51 and the sliding member 59 can be fixed together; the sliding member 59 can be slidably engaged with the sliding rails 581. The saddle 58 can be slidably positioned on the moving assembly 40. The main shaft 53 can pass through and be fixed with the connecting base 51. The milling cutting tool 55 can be hold by the rotation housing portion 535. The positioning block 574 can be fixed on the mounting portion 5715. The tool bracket 571 can be mounted on a sidewall of the fixing portion 531 via the locking members 573 and spaced from the milling cutting tool 55.

The workpiece 200 can be a metal worpiece with a striped shape. The workpiece 200 can have a plurality of being machining portions 201 in arrays. In an operation, the workpiece 200 can be positioned between the two groups of the driving members 353. The driving members 353 rotate the resisting members 355 in a certain degree. Two opposite sides of the workpiece 200 can be resisted against by the resisting members 355. The moving assembly 40 moves the machining mechanism 50, and the main shaft 53 rotates the milling cutting tool 55 for milling the being machining portions 201. After a milling progress, the main shaft 53 stops rotation. The moving assembly 40 moves the machining mechanism 50 in a preset position and moves along the first direction X. Then, some being machining portions 201 in a same array can be planed at one time linearly. In similar operations, the plurality of being machining portions 201 can be machined. The moving assembly 40 stops motion after machining.

In other embodiments, the positioning block 574 of the plane assembly 57 can be omitted. A being machining surface of the workpiece 200 can be machined in one time when a size of the to be machined surface of the workpiece 200 fits over a size of the cutting edge 5757. The angle formed between the mounting portion 5715 and the locating portion 5713 can be not limited in a range from about 90 degrees to about 180 degrees. The angle formed between the mounting portion 5715 and the plane 575 can be not limited in a range from about 90 degrees to about 180 degrees.

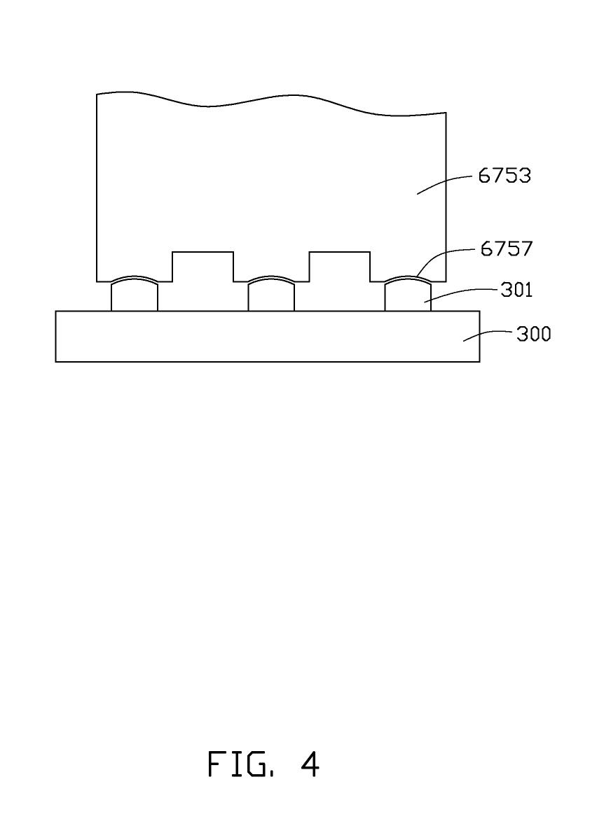

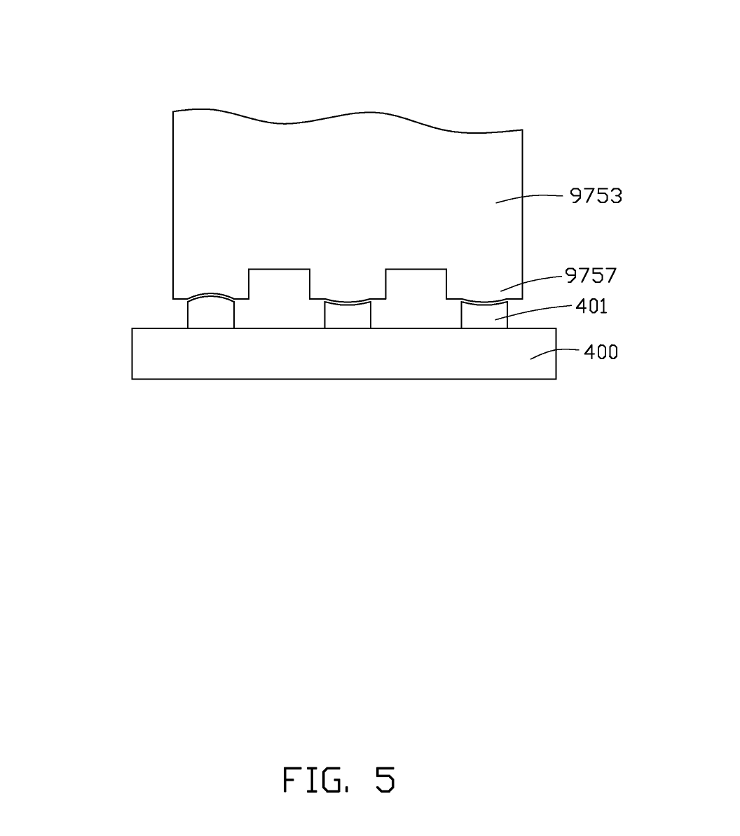

The number of the cutting edge 5757 and the shape of the cutting edge 5757 can be designed according to real application. FIG. 4 illustrates a cutting portion 6753 of a machine tool (not shown) of a second embodiment for machining being machining portions 6753. Structures of the machine tool of the second embodiment can be similar to the machine tool 100 of the first embodiment. The difference is that the cutting portion 6753 can include three separate cutting edges 6757 for machining three being machining portions 301 in one time for improving efficiency. FIG. 5 illustrates a cutting portion 9753 of a machine tool (not shown) of a third embodiment. Structures of the machine tool of the third embodiment can be similar to the machine tool 100 of the first embodiment. The cutting portion 9753 can include three separate cutting edges 9757. The difference is a shape of one cutting edge 9757 is different from other two cutting edges 9757 for machining out two different surfaces in one time.

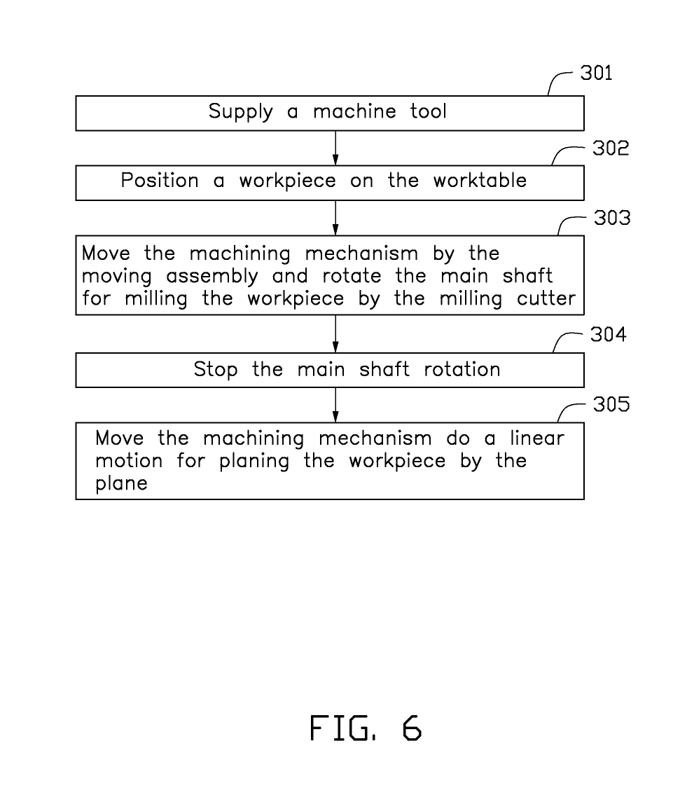

Referring to FIG. 6, a flowchart is presented in accordance with an example embodiment which is being thus illustrated. The example method is provided by way of example, as there are a variety of ways to carry out the method. The method described below can be carried out using the configurations illustrated in FIGS. 1 and 2, for example, and various elements of these figures are referenced in explaining example method. Each block shown in FIG. 6 represents one or more processes, methods or subroutines, carried out in the exemplary method. Additionally, the illustrated order of blocks is by example only and the order of the blocks can change according to the present disclosure. The exemplary method can begin at block 301.

At block 301, a machine tool is supplied.

The machine tool can include can include a support, a worktable, a moving assembly, and a machining mechanism. The worktable can be positioned on the support, and the moving assembly can be movably positioned on the support along a first direction X. The machining mechanism can be slidably positioned on the moving assembly along a second direction Y which is substantially perpendicularly to the first direction X. The machining mechanism also can move long a third direction substantially perpendicularly to the first direction X and the second direction Y relative to the moving assembly. The worktable can include a base body and a clamping device positioned on the base body. The base body can be positioned on the base. The clamping device can include a frame, four driving members, and four resisting members. The frame can include a bottom seat and a top board fixed on the bottom base. The four driving members can be divided into two groups including two driving members. The driving members can be arranged on the top board and received in the frame. A part of each driving member can protrude out from the top board. In the illustrated embodiments, the four driving members are rotary cylinders. The resisting members can be located outside of the frame and above the top board. Each resisting member can fixedly coupled to one driving member protruding from the frame. The resisting members can be configured to be rotated by the driving members to position the workpiece on the top board or release the workpiece.

The machining mechanism can include a connecting base, a main shaft, a milling cutting tool, and a plane assembly. The connecting base can be positioned on the moving assembly. The main shaft can include a fixing portion and a rotation housing portion rotatably coupled to the fixing portion. The fixing portion can pass through the connecting base and fixedly coupled to the connecting base. The fixing portion can protrude from the connecting base and extend toward the support. The rotation housing portion can be located above the worktable. The milling cutting tool can be stably held by the rotation housing portion. The rotation housing portion can be configured to rotate the milling cutting tool at high speed for milling the workpiece.

The plane assembly can be fixed on a sidewall of the fixing portion and spaced from the milling cutting tool. The plane assembly can include a tool bracket, a pair of locking members, a positioning block, and a plane. The tool bracket can include a locating portion and a mounting portion. The locating portion can be fixed on the fixing portion and substantially parallel to the main shaft. Two locking holes can be separately defined in locating portion. The mounting portion can protrude from one end of the locating portion away from the fixing portion and extend toward the support. An obtuse angle is formed between the locating portion and the mounting portion, which is greater than 90 degrees and less than 180 degrees. A strip-shaped and inclined receiving groove can be defined in a mounting portion away from the locating portion for holding the plane. The receiving groove can extend through two opposite sidewalls of the mounting portion. The positioning block can be located on the mounting portion and close one end of the receiving groove away from the support. Each locking member can pass through one locking hole and fixed with the fixing portion for fixing the tool bracket on the main shaft. The plane can be mounted in and received in the receiving groove. One end portion of the plane, which has a cutting edge, can protrude from the receiving groove and extend toward the support, such that the plane and the mounting portion can cooperative form a V-shaped structure. An angle formed between the mounting portion and the plane can be an obtuse angle.

At block 302, a workpiece can be positioned on the worktable by the clamping device.

At block 303, the moving assembly can move the machining mechanism and the rotation housing portion of the main shaft can rotate the milling cutting tool at high speed to mill the workpiece.

At block 304, the rotation housing portion can stop motion after milling.

At block 305, the moving assembly can move the machining mechanism do a linear motion and the plane can scrape the workpiece.

At block 306, the moving assembly can stop moving and the workliece can be taken out.

In other embodiments, steps described in block 303 and block 304 can be omitted, when only planing progress is required

Combination tracks for milling can be directly eliminated after the plane machines the workpiece. The workpiece does not need to be positioned in another machine for polishing or other treatments to eliminate the milling tracks. The workpiece can be just machined by the plane without milling, then nothing machining tracks leave after planing.

The embodiments shown and described above are only examples. Many details are often found in the art such as the other features of a moving assembly. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A machining mechanism comprising:
a connecting base connectable to a machine tool;
a main shaft housing coupled to a surface of the connecting base, the main shaft housing including a fixing portion coupled to the connecting base and a rotation housing portion extending from a surface of the fixing portion opposite to and substantially parallel to the surface of the fixing portion coupled to the connecting base;
a rotatable milling cutting tool extending out from the rotation housing portion opposite the fixing portion; and
a plane assembly attached to the fixing portion, the plane assembly comprising:
a tool bracket having a locating portion and a mounting portion, the mounting portion substantially parallel to the main shaft, and spaced apart from the milling cutting tool, the locating portion, with the mounting portion extending at an angle from the locating portion; and
a plane;
wherein, the locating portion of the tool bracket is attached to the fixing portion and the plane extends at an angle from the mounting portion away from the locating portion.

2. The machining mechanism of claim 1, wherein an angle formed between the mounting portion and the locating portion is in a range from about 90 degrees to about 180 degrees, and an angle formed between the mounting portion and the plane is in a range from about 90 degrees to about 180 degrees.

3. The machining mechanism of claim 2, wherein the location portion is substantially parallel to a vertical axis of the main shaft.

4. The machining mechanism of claim 1, wherein an inclined receiving groove is defined in the mounting portion away from the locating portion, and the plane is received and mounted in the receiving groove.

5. The machining mechanism of claim 4, wherein the plane comprises a positioning portion and a cutting portion extending from the positioning portion, the positioning portion is mounted in and received in the receiving groove.

6. The machining mechanism of claim 1, wherein the plane assembly further comprises a positioning block located on the mounting portion, the positioning block resists against the plane.

7. The machining mechanism of claim 1, wherein the plane comprises a plurality of cutting edges and the plurality of cutting edges separately formed at one end of the plane.

8. The machining mechanism of claim 7, wherein profiles of the plurality of cutting edges are not same.

9. A machine tool comprising:
a support;
a worktable positioned on the support;
a moving assembly movably positioned on the support;
a machining mechanism, comprising:
a connecting base connectable to the moving assembly;
a main shaft housing coupled to a surface of the connecting base, the main shaft housing including a fixing portion coupled to the connecting base and a rotation housing portion extending from a surface of the fixing portion opposite to and substantially parallel to the surface of the fixing portion coupled to the connecting base;
a rotatable milling cutting tool extending out from the rotation housing portion opposite the fixing portion; and
a plane assembly attached to the fixing portion, the plane assembly comprising:
a tool bracket having a locating portion and a mounting portion, the mounting portion substantially parallel to the main shaft, and spaced apart from the milling cutting tool, the locating portion, with the mounting portion extending at an angle from the locating portion; and
a plane;
wherein, the locating portion of the tool bracket is attached to the fixing portion and the plane extends at an angle from the mounting portion away from the locating portion.

10. The machine tool of claim 9, wherein the worktable comprises a base body and a clamping device positioned on the base body, and the base body is positioned on the support.

11. The machine tool of claim 10, wherein the clamping device comprises a frame, a plurality of driving members, and a plurality of resisting members, the frame fixed on the base body, the plurality of driving members are mounted in and received in the frame, each of the plurality of resisting members is coupled with one of the plurality of driving members, the plurality of resisting members are positioned outside of the frame, and the plurality of driving members is configured to drive the plurality of resisting members clamp or release the workpiece.

12. The machine tool of claim 11, wherein the frame comprises a bottom seat and a top board fixed on the bottom base, the plurality of driving members are mounted on the top board and received in the frame, and a part of each of the plurality of driving members protrudes out from the top board and coupled with the resisting members.

13. The machine tool of claim 9, wherein an angle formed between the mounting portion and the locating portion is in a range from about 90 degrees to about 180 degrees, and an angle formed between the mounting portion and the plane is in a range from about 90 degrees to about 180 degrees.

14. The machine tool of claim 9, wherein the location portion is substantially parallel to a vertical axis of the main shaft.

15. The machine tool of claim 9, wherein an inclined receiving groove is defined in the mounting portion away from the locating portion, and the plane is received and mounted in the receiving groove.

16. The machine tool of claim 15, wherein the plane comprises a positioning portion and a cutting portion extending from the positioning portion, the positioning portion is mounted in and received in the receiving groove.

17. The machine tool of claim 9, wherein the plane assembly further comprises a positioning block located on the mounting portion, the positioning block resists against the plane.

18. The machine tool of claim 9, wherein the plane comprises a plurality of cutting edges, the plurality of cutting edges separately formed at one end of the plane.

19. A method for machining a workpiece, comprising:
supplying a machine tool, the machine tool comprising:
a support;
a worktable positioned on the support;
a moving assembly movably positioned on the support; and
a machining mechanism comprising:
a connecting base connectable to the moving assembly;
a main shaft housing coupled to a surface of the connecting base, the main shaft housing including a fixing portion coupled to the connecting base and a rotation housing portion extending from a surface of the fixing portion opposite to and substantially parallel to the surface of the fixing portion coupled to the connecting base;
a rotatable milling cutting tool extending out from the rotation housing portion opposite the fixing portion; and
a plane assembly attached to the fixing portion, the plane assembly comprising:
a tool bracket having a locating portion and a mounting portion, the mounting portion substantially parallel to the main shaft, and spaced apart from the milling cutting tool, the locating portion, with the mounting portion extending at an angle from the locating portion; and
a plane;
wherein, the locating portion of the tool bracket is attached to the fixing portion and the plane extends at an angle from the mounting portion away from the locating portion;
positioning the workpiece on the worktable; and
moving the machining mechanism do a linear motion by the moving assembly, the plane cooperatively with the moving assembly machine a workpiece.

20. The method of claim 19, wherein the method further comprises two steps before moving the machining mechanism do a linear motion and after the workpiece is positioned on the worktable, the two steps are the main shaft rotates the milling cutting tool for milling the workpiece, and the main shaft stops rotation after milling.
